(19) United States
(12) Patent Application Publication
(10) Pub. No.: US 2015/0157112 A1
(43) Pub. Date: Jun. 11, 2015

(54) Cordless Electric Devices for Hair Care

(71) Applicant: Krystal Daibes, Portland, OR (US)

(72) Inventor: Krystal Daibes, Portland, OR (US)

(21) Appl. No.: 14/561,400

(22) Filed: Dec. 5, 2014

Related U.S. Application Data
(60) Provisional application No. 61/912,583, filed on Dec. 6, 2013.

(51) Int. Cl. A45D 44/06; H02J 7/00; A45D 20/12; A45D 2/00; A45D 1/04

(52) U.S. Cl. CPC A45D 44/06; A45D 2/001; A45D 1/04; A45D 20/12; H02J 7/0042; A45D 2001/045; A45D 2020/126

(57) ABSTRACT

A set of cordless hair care devices provides a curling iron, a hair straightener, and a blow dryer. Each of the devices features a rechargeable lithium-ion battery pack. In a second exemplary embodiment, a caddy, which may be placed on a counter or mounted on a wall, provides a contoured storage cradle for each of these devices, with a recessed recharging plug.

### CROSS-REFERENCE TO RELATED APPLICATIONS

This application claims the benefit of U.S. Provisional Application No. 61/912,583, filed Dec. 6, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hair care accessories, and in particular to cordless devices for hair care. Many women use electric hair straighteners, curling irons, and blow dryers. However, the power cords on these devices can be very cumbersome and annoying, particularly for those who own and use more than one of these devices. The devices are customarily used in the bathroom, and counter space may be limited or even nonexistent. Cordless power tools demonstrate the solution for this dilemma. A set of cordless hair care devices, including a curling iron, a hair straightener, and a blow dryer, is provided. Each of these devices features a rechargeable lithium-ion battery pack. In an alternate version, a caddy, which may be placed on a counter or mounted on a wall, provides a contoured storage cradle for each of these devices, with a recessed recharging plug. The user is enabled to move freely while using the devices, without being encumbered by power cords. These devices are particularly useful when traveling, or when used by a hair care professional in a salon.

### SUMMARY OF THE INVENTION

Accordingly, the invention is directed to a set of cordless hair care devices, including a curling iron, a hair straightener, and a blow dryer. Each of the devices features a rechargeable lithium-ion battery pack. In a second exemplary embodiment, a caddy, which may be placed on a counter or mounted on a wall, provides a contoured storage cradle for each of these devices, with a recessed recharging plug.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

FIG. 1 is a side perspective view of the three hair care devices and bottom view of the battery packs of the first exemplary embodiment, displaying the curling iron 10, the blow dryer 11, the straightener 12, the battery packs 13, the curling iron handle 13A, the blow dryer handle 13B, and the curling iron handle 13C.

FIG. 2 is a front transparency view of the second exemplary embodiment, displaying the curling iron 10, the blow dryer 11, the straightener 12, the caddy 14, the cradles 15, the recharging plugs 16, and the power cord 17.

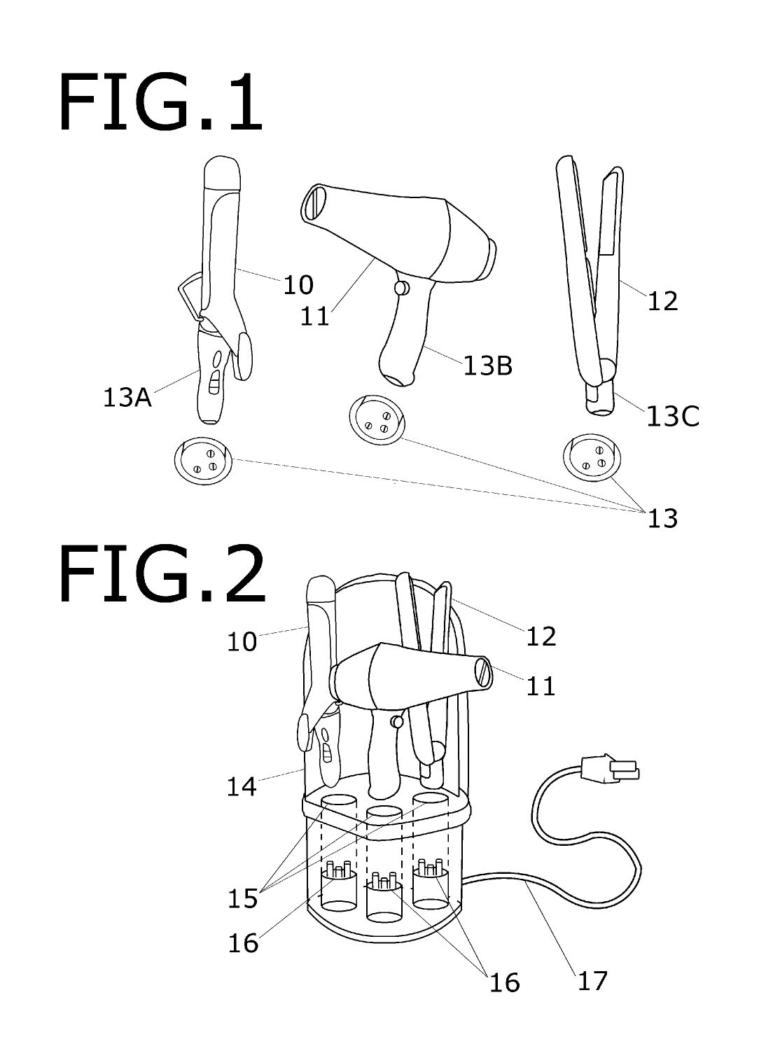

### DETAILED DESCRIPTION OF THE INVENTION

Referring now to the invention in more detail, the invention is directed to a system of cordless hair care devices, including a curling iron 10, a hair straightener 12, and a blow dryer 11. Each of the devices is equipped with a rechargeable and replaceable lithium-ion battery pack 13. In a second exemplary embodiment, a caddy 14, which may be placed on a counter or mounted on a wall, provides a contoured storage cradle 15 for each of these devices, with a recessed recharging plug 16.

The first exemplary embodiment is a curling iron 10, a hair straightener 12, or a blow dryer 11 which features a removable, rechargeable battery pack 13. The rechargeable and replaceable battery pack is releasably installed within the curling iron handle 13A, the blow dryer handle 13B, or the straightener handle 13C, and is configured to be in electrical communication with the curling iron 10, blow dryer 11, or straightener 12, when installed therein. The battery pack 13 may be recharged by plugging it into a recharger, which is provided. The recharger is powered by a standard power cord and may be plugged into a grounded wall outlet.

The second exemplary embodiment features all three devices, plus a caddy 14 which may be mounted on a wall. The caddy 14 is powered by a standard power cord, which may be plugged into a grounded wall outlet, and features three cylindrical recesses in its top surface, which serve as storage cradles 15 for the hair care devices. Preferably, the handles 13A, 13B, and 13C of all three devices are identically contoured and will fit into any of the three cradles 15. Each of the devices 10, 11, and 12 features an on/off switch on the side of the handles 13A, 13B, and 13C.

At the bottom of each cradle 15 is a recharging plug 16. The recharging plugs 16 fit into apertures in the battery packs 13 of the devices. Each of the recharging plugs 16 is configured so as to mate with the battery packs 13 so as to place the battery packs 13 in electrical communication with the recharging plugs 16, thereby linking the battery packs 13 to the power source of the recharging cord 17, which is in either direct or indirect electrical communication (for example via an AC-DC transformer). Preferably, the battery packs 13 of the devices are removable and interchangeable, and may be inserted separately into one of several cradles 15 for recharging; the cradles are preferably arranged in a triangular, nonlinear configuration, as shown in FIG. 2. The caddy 14 also has installed therein a retractable recharging cord 17, preferably eight feet in length, with which one of the devices may be used if its battery pack 13 has been discharged. Each of the cradles 15 features a light emitting diode (LED) on its exterior surface as an indicator light, to indicate when the battery pack 13 of the device in the cradle 15 has been fully charged. Alternate embodiments, featuring more detailed indications of the charge on each battery pack 13, such as multiple indicator lights or a meter to indicate various levels of recharging, are also contemplated.

The caddy 14 may be provided in alternate embodiments with one cradle 15, or two cradles 15, for those users who do not use and will not purchase all three devices.

To use the first exemplary embodiment, the user inserts a recharged battery pack 13 into the handle 13A, 13B, or 13C of the curling iron 10, hair straightener 12, or blow dryer 11. The user then activates the on/off switch and uses the device.

To use the second exemplary embodiment, the user plugs the power cord 17 of the caddy 14 into a grounded wall outlet, inserts the handle 13A of a device into a cradle 15, and turns the device and presses down until the prongs of the recharging plug 16 are engaged with the battery pack 13. The user may instead elect to remove the battery pack 13 from the handle 13A, 13B, or 13C of the selected device, and insert the battery pack 13 into the cradle 15 for recharging.

When the battery pack 13 is sufficiently charged, the user grasps the device or the battery pack 13, and pulls upward gently to disengage it from the recharging plug 16 and remove it from the cradle 15 for use. When the user is finished with the device, the user may return the device or its detached battery pack 13 to the cradle 15 to be recharged again.

The curling iron 10, the blow dryer 11, the straightener 12, the battery packs 13, the handles 13A, 13, and 13C, the caddy 14, and the recharger are preferably manufactured from rigid, durable materials, such as high-impact plastic, steel, brass, and aluminum. The recharging plugs 16 are preferably manufactured from copper alloys. The power cord 17 is preferably manufactured from a copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system of cordless electric hair care devices comprising: a curling iron; said curling iron being shaped with a curling iron handle; a blow dryer; said blow dryer being shaped with a blow dryer handle; a straightener; said straightener being shaped with a straightener handle; a plurality of battery packs; each of said plurality of battery packs being configured so as to be releasably installable within any of the group of said curling iron handle, said blow dryer handle, or said straightener handle; each of said plurality of battery packs being configured such that, when installed within said curling iron handle, said blow dryer handle, or said straightener handle, each of said plurality of battery packs is in electrical communication with one of the group of said curling iron, said blow dryer, or said straightener, respectively; a caddy; said caddy being shaped with a plurality of cradles; each of said plurality of cradles being shaped to conform to each of said plurality of battery packs; a plurality of recharging plugs; each of said plurality of cradles having installed therein one of said plurality of recharging plugs; each of said plurality of recharging plugs being configured so as to mate with any of said plurality of battery packs such that the two are placed in electrical communication.

2. The system of cordless electric hair care devices of claim 1 wherein said plurality of cradles is arranged in a nonlinear configuration.

3. The system of cordless electric hair care devices of claim 1 wherein said plurality of cradles is three in number and arranged in a triangular configuration.

4. The system of cordless electric hair care devices of claim 2 wherein said plurality of cradles is three in number and arranged in a triangular configuration.

5. The system of cordless electric hair care devices of claim 1 further comprising a recharging cord; said recharging cord being retractably stored within said caddy and in electrical communication with said plurality of recharging plugs.

6. The system of cordless electric hair care devices of claim 2 further comprising a recharging cord; said recharging cord being retractably stored within said caddy and in electrical communication with said plurality of recharging plugs.

7. The system of cordless electric hair care devices of claim 3 further comprising a recharging cord; said recharging cord being retractably stored within said caddy and in electrical communication with said plurality of recharging plugs.

8. The system of cordless electric hair care devices of claim 4 further comprising a recharging cord; said recharging cord being retractably stored within said caddy and in electrical communication with said plurality of recharging plugs.

9. An electric hair care device comprising an electric hair car device; said electric hair care being selected from the group of a blow dryer, a curling iron, or a straightener; said electric hair care device being; said hair care device being shaped with a handle; a battery pack; said battery pack being configured so as to be releasably installable within said handle; said battery pack being configured such that, when installed within said handle, said battery pack is in electrical communication with said electric hair care device.

10. The electric hair care device of claim 9 wherein said electric hair care device is a curling iron.

11. The electric hair care device of claim 9 wherein said electric hair care device is a blow dryer.

12. The electric hair care device of claim 9 wherein said electric hair care device is a straightener.
